(19) United States
(12) Patent Application Publication
(10) Pub. No.: US 2020/0040587 A1
(43) Pub. Date: Feb. 6, 2020

(54) JOINT BLOCK SUITABLE FOR BOTH RECTANGULAR PIPES AND ROUND PIPES

(71) Applicant: LILUN PLASTICS ENTERPRISE CO., LTD, CHANGHUA COUNTY (TW)

(72) Inventor: CHING-CHIH YU, CHANGHUA COUNTY (TW)

(21) Appl. No.: 16/052,906

(22) Filed: Aug. 2, 2018

(51) Int. Cl. E04F 11/18; F16B 9/00

(52) U.S. Cl. CPC E04F 11/1812; F16B 9/054

(57) ABSTRACT

A joint block suitable for both rectangular pipes and round pipes has a base having a plurality of separated elastic petals evenly and peripherally disposed at an end of the base. A through aperture is disposed in a center position of the base, another end of the base has a circular ring, and the circular ring comprising at least a facet providing a contact surface. An outer surface of the circular ring contacts an inner surface of the round tubular railing, the contact surface contacts an inner surface of the rectangular tubular railing, and the elastic petals pushes against the inner surface of the round tubular railing or the rectangular tubular railing.

### BACKGROUND of INVENTION

### 1. Field of Invention

The present invention relates to a joint block, and more particularly to a joint block suitable for both rectangular pipes and circular pipes.

### 2. Description of the Related Art

A conventional railing joint structure includes a block and a bolt. The block has a through hole at one end, and an engaging hole is formed at the other end of the block, with the through hole having a larger diameter than the engaging hole. The bolt is provided with a head portion at one end. The bolt is disposed at the engaging hole, and the head portion of the bolt is mounted at the through hole, so that the block can be locked on the ground. Therefore, the railing can be assembled with the block to form a rapid ground assembly for a handrail. However, it is not difficult to determine that the above-mentioned conventional structure has some shortcomings, with the main reasons being as follows: in order to match round pipes and square pipes, the block will be formed with a cylindrical shape or a rectangular columnar shape. In order to achieve this, the conventional method is to use two different molds shapes. However, this method not only increases the costs of production and preparation, but also requires users to assemble different blocks when selecting different railings, which also causes assembly inconvenience.

Therefore, it is desirable to provide a joint block suitable for both rectangular pipes and circular pipes to mitigate and/or obviate the aforementioned problems.

### SUMMARY OF THE INVENTION

An objective of present invention is to provide a joint block, which is capable of improving the above-mention problems.

In order to achieve the above mentioned objective, a joint block suitable for both rectangular pipes and round pipes has a base having a plurality of separated elastic petals evenly and peripherally disposed at an end of the base. A through aperture is disposed in a center position of the base, another end of the base has a circular ring, and the circular ring comprising at least a facet providing a contact surface. An outer surface of the circular ring contacts an inner surface of the round tubular railing, the contact surface contacts an inner surface of the rectangular tubular railing, and the elastic petals pushes against the inner surface of the round tubular railing or the rectangular tubular railing.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment of the present invention.

FIG. 2 is a schematic drawing of the preferred embodiment of the present invention applied to a circular pipe or a square pipe railing.

FIG. 3 is a perspective cross-sectional view of a circular tubular railing according to the present invention.

FIG. 4 is a transverse cross-sectional view of the circular tubular railing according to the present invention.

FIG. 5 is a longitudinal cross-sectional view of the circular tubular railing according to the present invention.

FIG. 6 is a perspective cross-sectional view of a rectangular tube railing according to the present invention.

FIG. 7 is a transverse cross-sectional view of the rectangular tubular railing according to the present invention.

FIG. 8 is a longitudinal cross-sectional view of the rectangular tubular railing according to the present invention.

FIG. 9 is a schematic view of the present invention assembled on a predetermined plane.

FIG. 10 is a perspective view of another embodiment of the present invention.

FIG. 11 is a schematic view of embodiment of the present invention assembled on a predetermined inclined surface.

### DETAILED DESCRIPTION OF THE PREFERRED EMBODIMENT

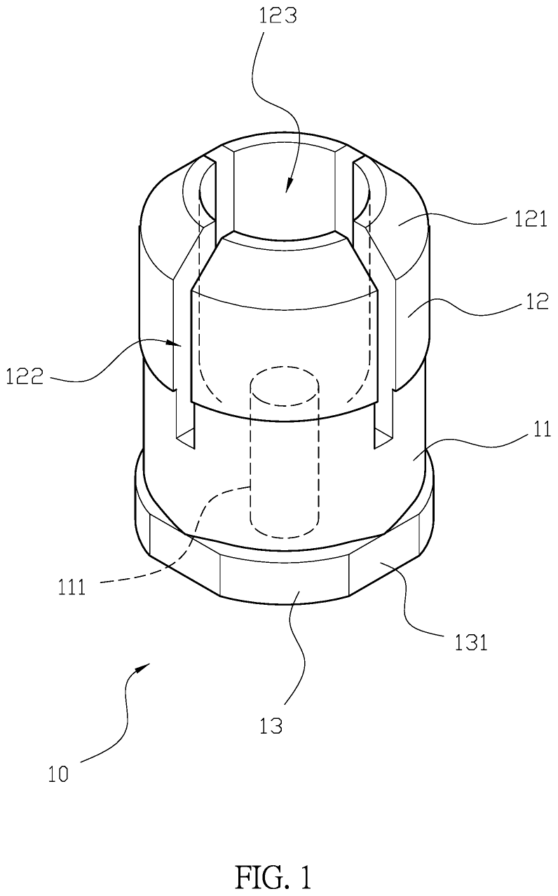

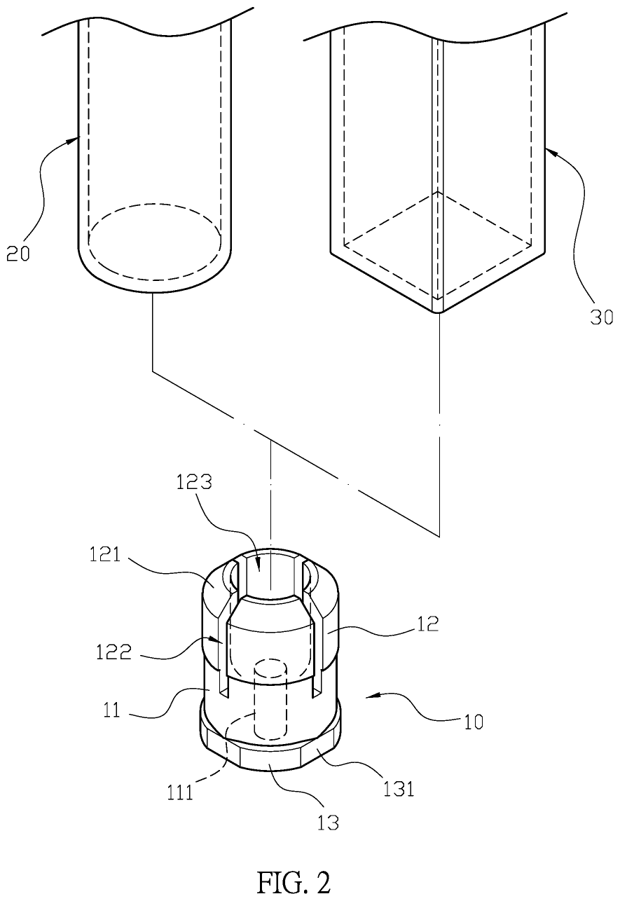

Please refer to FIG. 1 and FIG. 2. The A joint block 10 is provided with a base 11. The joint block 10 has a plurality of the elastic petals 12 extending from one end of the base 11, and the elastic petals 12 is formed with a chamfer 121 at an the end away from of the base 11. A flexible gap 122 is formed between the elastic petals 12, and a central hole 123 is formed by the surrounding elastic petals 12. A through aperture 111 is provided through the center of the base 11 and aligned with the central hole 123. The joint block 10 is provided with a locking member 14 (shown in FIG. 5) at the through aperture 111. A circular ring 13 is disposed at another end of the base 11, and an outer circumference of the circular ring 13 is flattened to form four contact surfaces 131. An outer diameter of the circular ring 13 is larger than the outer diameter of the base 11. The distance between the two symmetrical contact surfaces 131 is equal to the outer diameter of the base 11. The outer circumference of the other circular ring 13 makes contact with an inner wall of the round tubular railing 20, and the contact surface 131 pushes against the inner wall of the rectangular tubular railing 30. Furthermore, the elastic petals 12 provide support on the inner wall of the round tubular railing 20 or the rectangular tubular railing 30. Therefore, the joint block 10 is suitable for the round tubular railing 20 and the rectangular tubular railing 30.

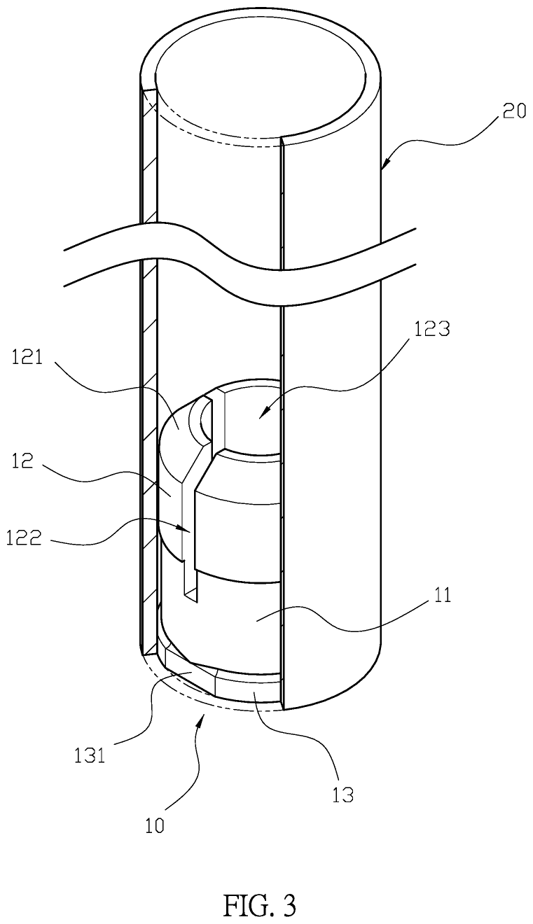

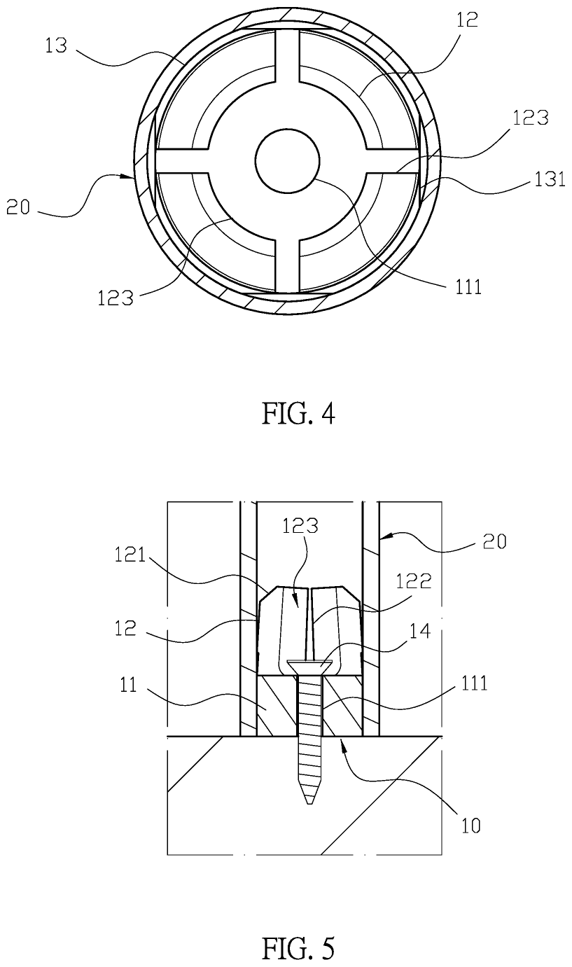

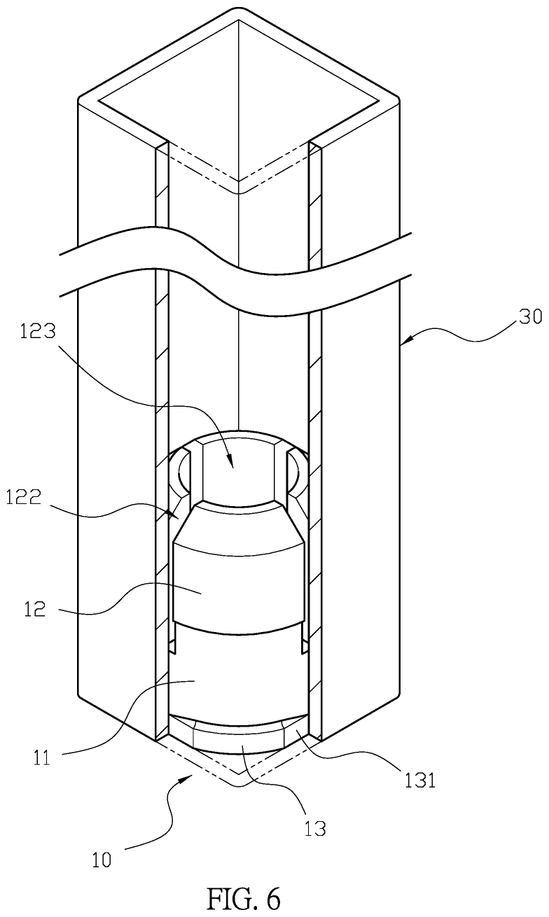

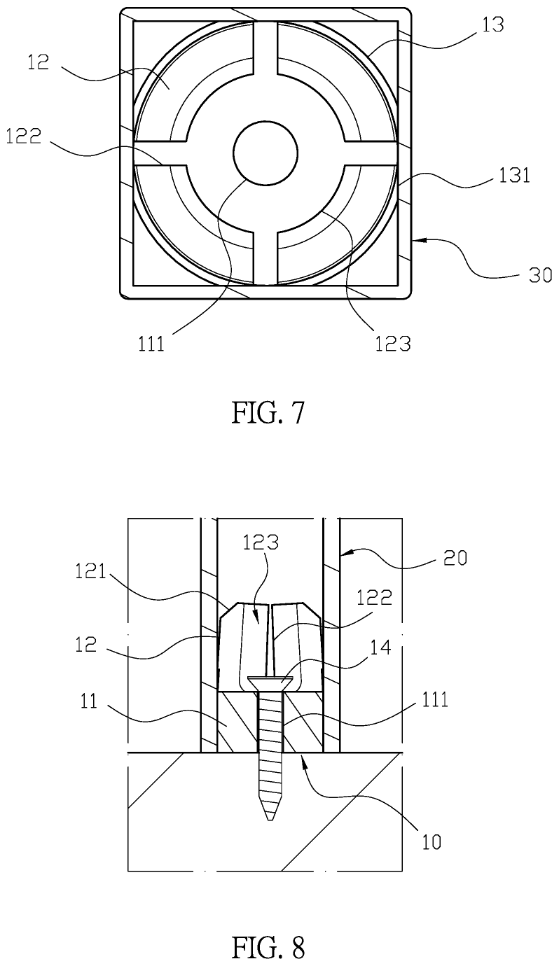

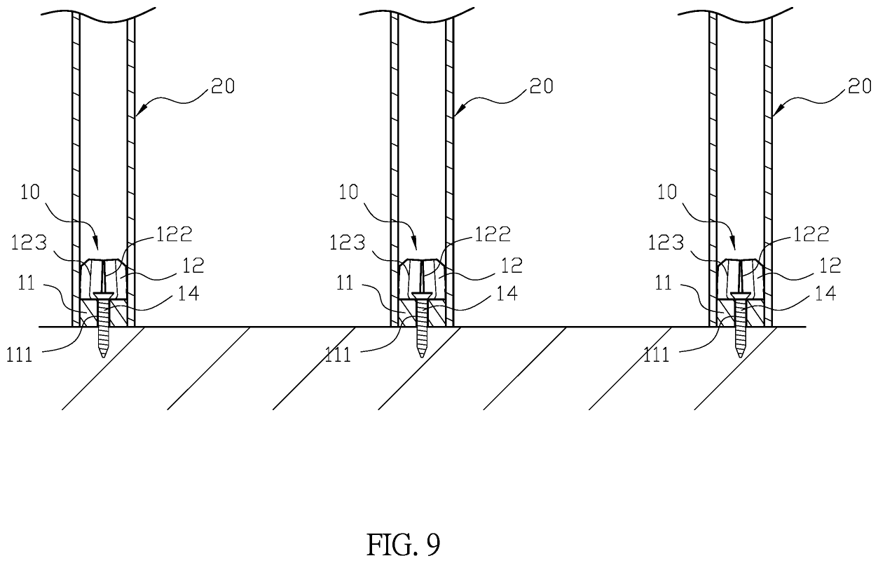

For actual operation, please refer to FIG. 1 to FIG. 5. In order to connect the joint block 10 with the round tubular railing 20, the joint block 10 is first placed at a predetermined surface, and the locking member 14 is inserted into the through aperture 111 from the central hole 123 to lock the joint block 10 at a desired location, so that the elastic petals 12 are disposed vertically upward. Afterward, one end of the round tubular railing 20 is sleeved onto the elastic petals 12 of the joint block 10, and the chamfer 121 of the elastic petal 12 assists the round tubular railing 20 to sleeve onto the joint block 10. And the inner wall of round tubular railing 20 squeezes the elastic petals 12. The central hole 123 and the elastic gap 122 allow the elastic petals 12 to achieve elastic deformation, and then the elastic petals 12 expand to abut against the inner wall of the round tubular railing 20. Furthermore, pressing the round tubular railing 20 toward the base 11 to make the inner wall of the round tubular railing 20 in contact with the outer circumference of the circular ring 13. Thereby, the elastic petals 12 and the circular ring 13 form a two-stage secure effect to achieve a stable connection between the round tubular railing 20 and the joint block 10. In order to connect the joint block 10 with the rectangular tubular railing 30, please refer to FIGS. 6, 7, and 8. The joint block 10 is secured at a predetermined location by the locking member 14 through the through aperture 111, and the rectangular tubular railing 30 is directly sleeved onto the elastic petals 12. The elastic petals 12 are squeezed into the rectangular tubular railing 30 and then elastically expand to push against the inner wall of the rectangular tubular railing 30. Afterward, the rectangular tubular railing 30 is pushed further down to sleeve onto the circular ring 13, so that the contact surface 131 of the circular ring 13 makes contact with the inner wall of the rectangular tubular railing 30. Therefore, the elastic petals 12 and the contact surface 131 form a two-stage secure effect, the contact surface 131 prevents the rectangular tubular railing 30 from being rotated. In summary, the elastic petals 12 and the circular ring 13 of the joint block provide two-stage secure effect to combine the joint block 10 and the railing together firmly. As shown in FIG. 9, the railings can be arranged in an equidistant manner by quick assembly. Furthermore, the four facets of the circular ring 13 of the joint block 10 provides the contact surface 131 at the circumference, so that the joint block 10 can be applied to the round tubular railing 20 and the rectangular tubular railing 30 at the same time, which not only reduces the mold opening cost and the preparation cost, but also helps to improve the ease of assembly. In other words, it allows the consumer to directly assemble the round tubular railing 20 or the rectangular tubular railing 30 with the same joint block 10, which combines cost-effective and easy-to-assemble benefits.

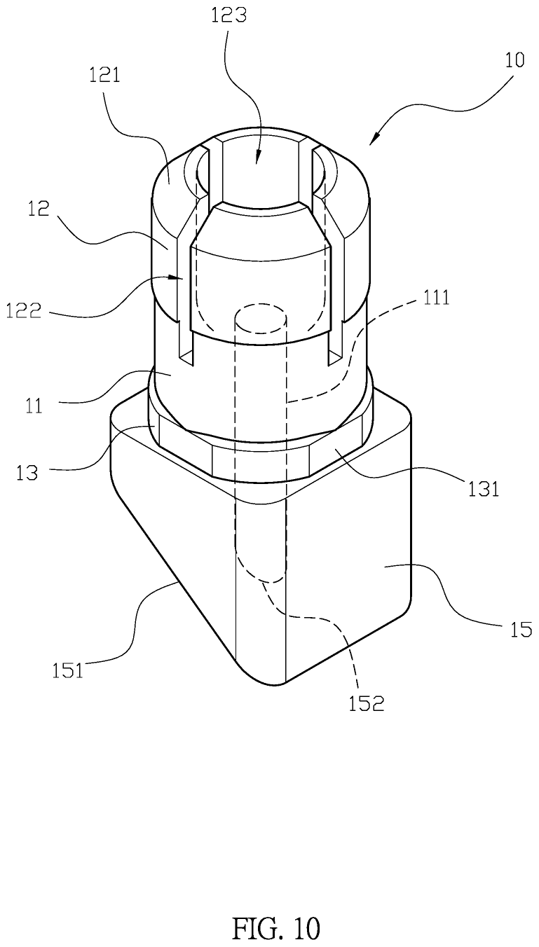

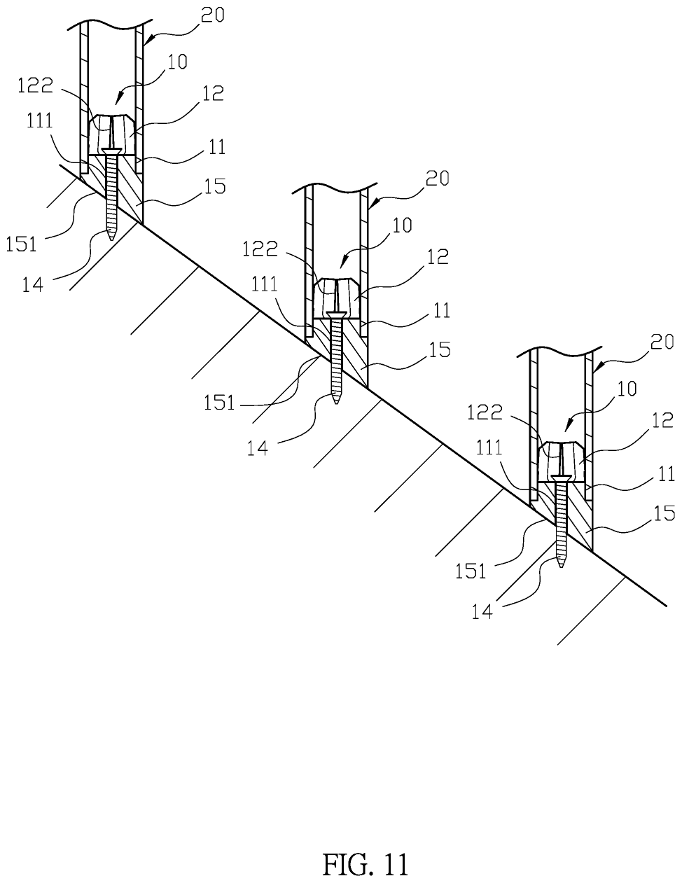

In another embodiment of the present invention, as shown in FIGS. 10 and 11, the joint block 10 is provided with an extending block 15 at one end of the circular ring 13, and the extending block 15 is formed with an inclined surface 151. The extending block 15 is provided with a passing hole connected to the through aperture 111. The joint block 10 and the extending block 15 can be integrally formed, or alternatively the joint block 10 and the extending block 15 can also be a two-piece combination. The inclined surface 151 of the extending block 15 is placed a predetermined inclined location, which allows the elastic petals 12 of the joint block 10 being kept vertically upward. Then, the locking member 14 is locked onto the inclined location through the through aperture 111 and the passing hole 152. Finally the round tubular railing 20 or the rectangular tubular railing 30 is combined with the joint block 10.

Although the present invention has been explained in relation to its preferred embodiment, it is to be understood that many other possible modifications and variations can be made without departing from the spirit and scope of invention as hereinafter claimed.

What is claimed is:

1. A joint block suitable for both rectangular pipes and round pipes comprising:
a base having a plurality of separated elastic petals evenly and peripherally disposed at an end of the base, a through aperture disposed in a center position of the base, another end of the base having a circular ring, the circular ring comprising at least a facet providing a contact surface; an outer surface of the circular ring contacting an inner surface of the round tubular railing, the contact surface contacting an inner surface of the rectangular tubular railing, the elastic petals pushing against the inner surface of the round tubular railing or the rectangular tubular railing.

2. The joint block suitable for both rectangular pipes and round pipes as claimed in claim 1, wherein the through aperture of the joint block further comprises a locking member for external engagement.

3. The joint block suitable for both rectangular pipes and round pipes as claimed in claim 2, wherein the joint block further comprises an extending block at the end with the circular ring, and the extending block is provided with an inclined surface and a passing hole aligned with the through aperture.

4. The joint block suitable for both rectangular pipes and round pipes as claimed in claim 3, wherein the joint block and the extending block are integrally formed.

5. The joint block suitable for both rectangular pipes and round pipes as claimed in claim 3, wherein the joint block and the extending block are two separate pieces.

6. The joint block suitable for both rectangular pipes and round pipes as claimed in claim 1, wherein an edge of an end of the elastic petals opposite to the base is chamfered.

7. The joint block suitable for both rectangular pipes and round pipes as claimed in claim 1, wherein an outer diameter of the circular ring is larger than an outer diameter of the base, and a distance between two opposite contact surfaces is equal to the outer diameter of the base.
